(19) United States
(12) Patent Application Publication
(10) Pub. No.: US 2014/0317455 A1
(43) Pub. Date: Oct. 23, 2014

(54) LPC BUS DETECTING SYSTEM AND METHOD

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: Ming YU, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/138,128

(22) Filed: Dec. 23, 2013

(30) Foreign Application Priority Data
Apr. 23, 2013 (CN) 2013101421446

(51) Int. Cl. G06F 11/07

(52) U.S. Cl. CPC G06F 11/0787
USPC 714/48

(57) ABSTRACT

A LPC bus detecting system includes a PLD for detecting a LPC bus of a server. The PLD includes a detecting module connected to the LPC bus and an Embedded Block RAM (EBR) connected to the detecting module. The detecting module is capable of decoding signals transferred by the LPC bus and storing decoded data to the EBR. The present disclosure further discloses a method for detecting the LPC bus.

### BACKGROUND

1. Technical Field

The present disclosure relates to a low pin count (LPC) bus detecting system and method.

2. Description of Related Art

A typical server includes a south bridge chip, an I/O chip connected to the south bridge chip via a LPC bus, and a programmable logic device (PLD) connected to the LPC bus. The PLD detects and decodes signals transmitted by the LPC bus. The decoded data is stored in a plurality of distributed memories of the server. However, the plurality of distributed memories sometimes does not have enough storage capacity to store the decoded data.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a LPC bus detecting system.

FIG. 2 is a detailed block diagram of a detecting module of FIG. 1.

FIG. 3 is a flow chart of an embodiment of a LPC bus detecting method.

### DETAILED DESCRIPTION

The disclosure is illustrated by way of example and not by way of limitation. In the figures of the accompanying drawings in which like references indicate similar elements. It should be noted that references to “an” or “one” embodiment in this disclosure are not necessarily to the same embodiment, and such references mean “at least one.”

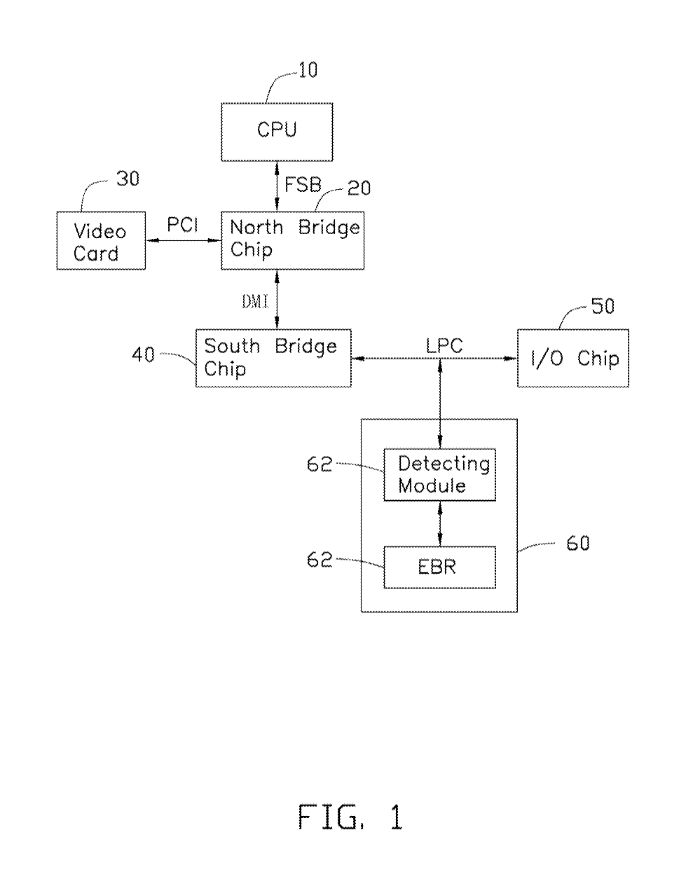

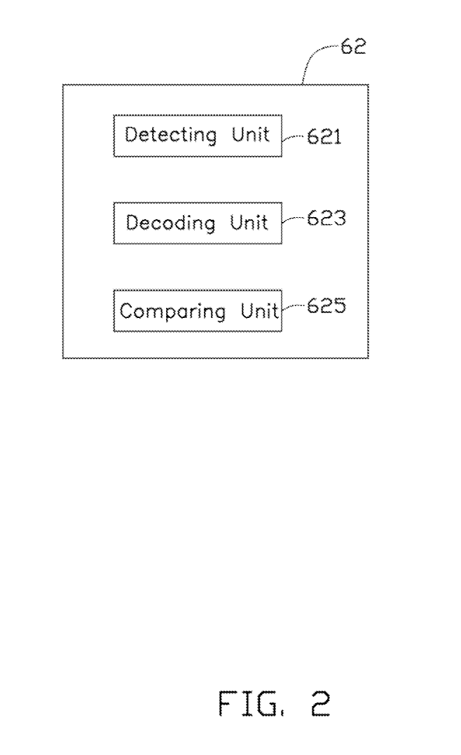

FIGS. 1 and 2 show an embodiment of a LPC bus detecting system, which includes a CPU 10, a north bridge chip 20, a video card 30, a south bridge chip 40, an I/O chip 50, and a PLD 60. In one embodiment, the CPU 10, the north bridge chip 20, the video card 30, the south bridge chip 40, the I/O chip 50, the PLD 60 are mounted on a motherboard of a server.

The north bridge chip 20 is connected to the CPU 10 via a front side bus (FSB). The video card 30 is connected to the north bridge chip 20 via a PCI bus. The south bridge chip 40 is connected to the north bridge chip 20 via a direct media interface (DMI). The I/O chip 40 is connected to the south bridge chip 40 via a LPC bus. The I/O chip 50 is used for connecting input/output devices, such as a keyboard, a mouse, and microphone.

The PLD 60 includes a detecting module 62 connected to the LPC bus and an Embedded Block RAM (EBR) 64 connected to the detecting module 62. The detecting module 62 includes a detecting unit 621, a decoding unit 623, and a comparing unit 625. The detecting unit 621 is used for detecting signals transmitted by the LPC bus. The decoding unit 623 is used for decoding the signals detected by the detecting unit 621 and stores decoded data in the EBR 64. The comparing unit 625 compares the decoded data with predetermined parameters. If the decoded data conforms to the predetermined parameters, there is no error data detected by the detecting module 62. If the decoded data does not conform to the predetermined parameters, there is error data detected by the detecting module 62. In one embodiment, the PLD 60 is a Complex Programmable Logic Device (CPLD) chip or a Field-Programmable Gate Array (FPGA) chip.

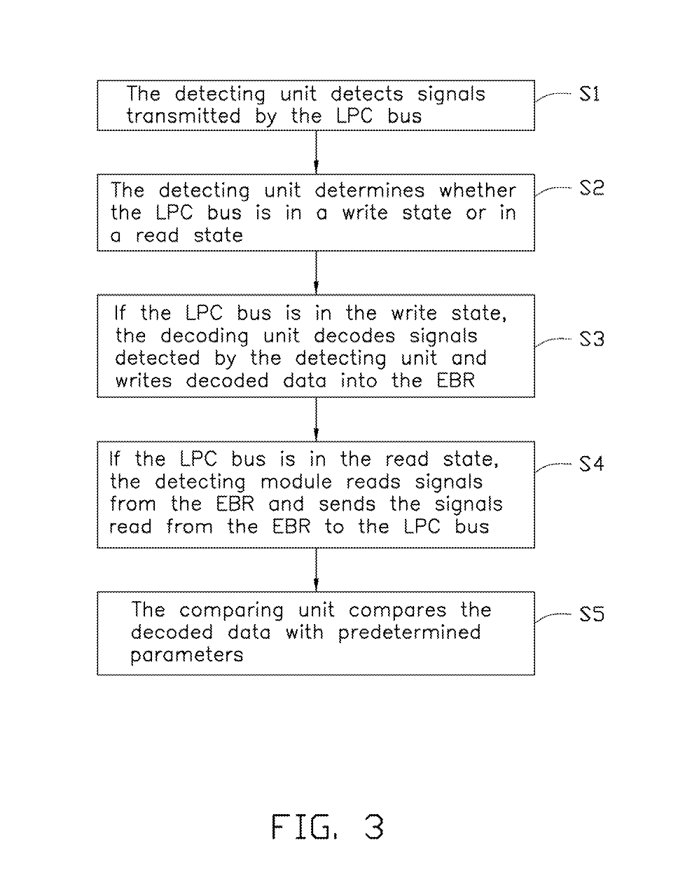

FIG. 3 shows a flow chart of a LPC bus detecting method based upon the LPC bus detecting system. The LPC bus detecting method includes the following blocks.

In block S1, the detecting unit 621 detects signals transmitted by the LPC bus.

In block S2, the detecting unit 621 determines whether the LPC bus is in a write state or in a read state.

In block S3, if the LPC bus is in the write state, the decoding unit 623 decodes signals detected by the detecting unit 621 and writes decoded data into the EBR 64.

In block S4, if the LPC bus is in the read state, the detecting module 62 reads signals from the EBR 64 and sends the signals read from the EBR 64 to the LPC bus.

In block S5, the comparing unit 625 compares the decoded data with predetermined parameters. If the decoded data conforms to the predetermined parameters, there is no error data detected by the detecting module 62. If the decoded data does not conform to the predetermined parameters, there is error data detected by the detecting module 62.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain of the steps of methods described may be removed, others may be added, and the sequence of steps may be altered. It is also to be understood that the description and the claims drawn to a method may include some indication in reference to certain steps. However, any indication used is only to be viewed for identification purposes and not as a suggestion as to an order for the steps.

What is claimed is:

1. A system for detecting a LPC bus of a server, the system comprising:
a PLD comprising a detecting module connected to the LPC bus and an embedded block RAM connected to the detecting module; wherein the detecting module is configured for decoding signals transferred by the LPC bus and storing decoded data to the Embedded Block RAM.

2. The system of claim 1, wherein the detecting module comprises a detecting unit configured for detecting the signals transferred by the LPC bus, a decoding unit configured for decoding the signals transferred by the LPC bus, and a comparing unit configured for comparing the decoded data with predetermined parameters.

3. The system of claim 2, further comprising a south bridge chip and an I/O chip connected to the south bridge chip via the LPC bus.

4. The system of claim 3, further comprising a CPU, a north bridge chip connected to the CPU via a front side bus, and a video card connected to the north bridge chip via a PCI bus; wherein the south bridge chip is connected to the north bridge chip via a direct media interface.

5. The system of claim 4, wherein the PLD is a CPLD chip or a FPGA chip.

6. A method for detecting a LPC bus of a server, the method comprising:
detecting signals transmitted by the LPC bus by a detecting unit of a PLD;
decoding the signals to obtain decoded data by a decoding unit of the PLD; and
storing the decoded data in an Embedded Block RAM (EBR) of the PLD.

7. The method of claim 6, further comprising determining whether the LPC bus is in a write state or a read state before the decoding step.

8. The method of claim 7, wherein if the LPC bus is in the write state, the decoding unit writes the decoded data into the EBR.

9. The method of claim 7, wherein if the LPC bus is in the read state, the detecting module reads signals from the EBR and sends the signals read from the EBR to the LPC bus.

10. The method of claim 7, further comprising comparing the decoded data with predetermined parameters by a comparing unit of the PLD; wherein if the decoded data conforms to the predetermined parameters, determining there is no error data detected by the detecting module; if the decoded data does not conform to the predetermined parameters, determining there is error data detected by the detecting module.
